(19) United States
(12) Patent Application Publication
(10) Pub. No.: US 2007/0292310 A1
(43) Pub. Date: Dec. 20, 2007

(54) Microanalysis Apparatus with Constant Pressure Pump System

(75) Inventor: Peter Gravesen, Nordborg (DK)

Correspondence Address: MCCORMICK, PAULDING & HUBER LLP, CITY PLACE II, 185 ASYLUM STREET, HARTFORD, CT, 06103, US

(73) Assignee: Danfoss A/S, Nordborg (DK)

(21) Appl. No.: 11/596,699

(22) PCT Filed: May 13, 2005
(86) PCT No.: PCT/DK05/00321

§ 371 Date: Apr. 12, 2007

(30) Foreign Application Priority Data
May 17, 2004 (DE) PA 2004 00786

(51) Int. Cl. B01J 19/00

(52) U.S. Cl. 422/68.1

(57) ABSTRACT

Micro fluidic system for analysing species within a fluid medium includes at least one first fluid reservoir (12) holding a carrier fluid, a second fluid reservoir(s) (13-15) holding reagent fluid(s) producing measurable chemical reactions when mixed with the species, detecting arrangement (54) able to detect the measurable chemical reactions, a membrane (61) permeable to the species, the membrane being in downstream fluid communication with the first fluid reservoir (12) and in upstream fluid communication with analysing mechanism (50), the first fluid reservoir(s) and the second fluid reservoir(s) being stored in storage container (10) and in downstream fluid communication with pressurizing mechanism through connecting mechanism (6), wherein the analysing mechanism comprise one substrate with micro-channels and covered in a fluid tight manner by a sheet, the micro-channels at said one substrate defining at least one meandering part(s) (51, 52) for mixing and/or reacting the reagent fluid(s) to the carrier fluid, and at least one meandering part (53) for measuring the resulting detectable changes from the reaction, and an outlet (55) for the waste fluid.

### CROSS REFERENCE TO RELATED APPLICATIONS

This application is entitled to the benefit of and incorporates by reference essential subject matter disclosed in International Patent Application No. PCT/DK2005/000321 filed on May 13, 2005 and Danish Patent Application No. PA 2004 00786 filed May 17, 2004.

### FIELD OF THE INVENTION

The present invention relates to a microanalysis apparatus and, more particularly, to a microanalysis apparatus with a constant pressure pump system.

### BACKGROUND OF THE INVENTION

A micro-analysis system preferable for analysing the concentration of species, like the concentration of glucose in body tissue, where the analysis is based on the mixing of at least two fluids. These fluids typically comprise a carrier fluid and reagent fluids, being propagated in the system by means of a constant pressure system. The carrier fluid are lead past a membrane by means of a channel, where the membrane separates the interior of the system from the media to be analysed, enabling the species to permeate from the media to the carrier fluid enriching it with the species. Such a carrier fluid containing a concentration of the species are normally referred to as sample fluid. Having passed the membrane the sample fluid is then mixed with one or more reagent fluids by laminar mixing, a way of mixing being preferred due to the small channel dimensions, the constant and small flow rates in the system. The reaction then produces a product suitable for generation of a measuring signal in a detector of the analysis system.

It is known technology to use micro-flow systems with micro-channels formed in silicon or glass for chemical analysis. An example is a system for flow injection analyses described in U.S. Pat. No. 5,644,395 where small quantities of chemical reagents and sample are intermixed and reacted within such a flow system, where the dimensions ensure capillary flow, and the reaction products are detected optically, electrochemically, or by other means. To regulate the flows micro-valves are mounted on the surface. The capillary channels comprise a section for mixing of the fluids, a section for the needed reactions to occur and a detection section.

It is also known to use the technique of analysing by chemical reaction in the field of micro-dialysis for continuously monitoring the concentration of species like glucose in tissue. In U.S. Pat. No. 5,640,954 a micro-dialysis probe is implanted in tissue and fed by a perfusion fluid that is removed as sample after enrichment with the species from the tissue. The fluids are lead through a tube system, where an enzyme is added and an electrochemical sensor registers a measurable chemical reaction. The flow rates in the system are quite small being in the range from 0.1 to 15 micro litre pr. minutes. To produce the flows a first and a second transport means are introduced, preferable in form of rolling or piston pumps, where a compact set-up would be to use a single pump and control the flow rates by using tubes with different diameters.

In another patent U.S. Pat. No. 6,572,566 the idea of having flows in channels are combined with direct analysis of a body fluid. The systems contains integrated reservoirs connected to the channels and an exchange region through which the substances from surrounding body fluids can be taken up into the channel, e.g. through a dialysis membrane. To propagate the fluids a pumping system is suggested based on a pressure container filled with a pressurized gas being in contact with a second container split in two parts by a flexible member. The first part contains a liquid and the second part receives the pressurized gas, displacing the flexible member and squeezing liquid into a channel system. A flow restrictor is located downstream of the pumping system to limit the amount of liquid emerging from the reservoir and keep the flow constant.

A document WO 99/39629 describes an implantable sensing arrangement having long-term stability. The sensing arrangement utilizes microdialysis sampling techniques and includes a micro-flow reservoir (10a) having a reagent which reacts with a target chemical and a sensor (80a) connected to the micro-flow reservoir (10a) for detecting the reaction of the reagent and the target chemical. The sensor may include a thermopile (80) or optical cell.

In one sensing arrangement, the invention includes (i) an optical cell and (ii) microdialysis tubing. This sensing arrangement combines microdialysis sampling techniques with the use of a microflow system employing an optical cell to create a system that can accurately measure the concentration of glucose and other chemicals in complex solutions bearing proteins.

In this embodiment, the biochemical sensing system, as illustrated by FIG. 5, includes a pressurized container 300 which includes collapsible bags, typically made of MYLAR, 304 for holding reagents, calibration solution 302, and sweep solution 306. These are regulated in their flow by resistance tubing, as hereinbefore described, whose diameter and length can been selected to achieve flow rates typically in the sub-microliter per minute regime. For example, a 25 centimeter length of 15 micron diameter silica resistance tubing, and with a 10 psi charging pressure in the container squeezing on the reagent bag will produce a flow rate of approximately 300 nl/minute.

The sweep solution is typically regulated to a flow rate which is slower by about 20-50 times, i.e., in the tens of nanoliter per minute rate, than the reagent in order to achieve a correct proportion in mixing. Although the mixing ratios will differ according to a specific reagent, the mixing ratio reagent to sweep fluid for the Trinder test is from about 20:1 to about 200:1. The sweep solution is introduced by connecting tubing, typically microbore tubing, to a microdialysis fiber 308 that is in diffusive contact with the test environment 310, e.g., a bioreactor perfusion loop. At flow rates of approximately 300 nl/min. and a retention time of about 2 minutes through a microdialysis fiber 308 of about 10 to mm. long, the target-chemical concentration in the sweep fluid can reach diffusive equilibrium with the test environment. The return dialysate (i.e., sweep fluid containing the target-chemical) is then mixed with the particular reagent. The mixed solutions move down a single tube or capillary 330 where the chemical reaction of the reagent with glucose proceeds and the optical change occurs, i.e., the reagent-dialysate mixing volume. The absorbance of the flow stream at the specific color of a chemically sensitive dye is measured by an optical cell 320 having a light emitting diode and miniature diode photodetector. The resulting photodetector signal is calibrated in terms of glucose concentration by the microcontroller 340.

The microdialysis tubing 308, also referred to as a membrane hollow fiber, in contact with the test solution test is made from a material which is permeable to glucose but excludes large molecular weight materials. Typically, the microdialysis tubing is made of materials such as cellulose acetate, polysulfone, and polyacrylonitrile, usually in the form of hollow tubes on the order of 200 microns in diameter. The reagents that are mixed with the sweep fluid are chosen so that their color or fluorescence change has a specific response to the biochemical desired, as is well known in the art.

An optical cell 320 at the receiving end of the mixed reagent flow stream measures color or fluorescence change, and the signal obtained therefrom is related to chemical concentration by microcontroller 340.

The micro-flow reagent reservoir may be remote from the sensor and connected to it by a catheter containing microbore tubing.

As can be seen from FIG. 2 the micro-flow reagent reservoir 10a includes housing or containment 10c and a collapsible bag 20 for holding the reagent solution. A tubing arrangement has an open ended tubing portion 30 arranged in a curled position inside the bag 20 and tubing portion 50 located outside the bag 20 which connects the reservoir 10a to the sensor system 80A. In an alternate arrangement the tubing portion 30 may be wrapped as a coil around a collapsible bag and housed within the containment.

This system however is not very suitable when a number of reagent fluids are mixed to the sweep fluid, or sample fluid. This is especially the case if a first fluid needs to have mixed sufficient with the sweep fluid, before a second reaction fluid is added. The reason is that a connecting tube would be needed for the sweeping fluid and each of the different reagent fluids, and further tubes would be needed after each of the mixings, to give the reactions time to complete before news reagent fluids are added. This would require a number of connections of the different tubes, thereby enhancing the number of manufacturing steps, and the possibilities of harming one of the small and relative fragile tubes. Further, given the micro dimensions of the tubes, it may be difficult to align them correctly and smooth, so that the fluids to be mixed are laminated and mixed in a determined laminar and engineered manner.

### BRIEF SUMMARY OF THE INVENTION

The object of the present invention is to overcome the described problems of the prior art. How this is achieved is described in the following.

This invention is of the kind where a sample fluid is created by an exchange of ions via a membrane, the membrane separating a carrier fluid inside the system from the media to be analysed. The membrane may cover a probe being separated from but in fluid contact with the rest of the system, or it may be build into a housing covering the system, possibly having the housing partly or totally immersed into the media.

The analysing process is the known technology of mixing the sample with fluids of at least one reagent liquid, producing some changes of the fluid being detectable by some detecting means coupled to the system, and being representative for the concentration of the species in the media being analysed. The detecting means generates a corresponding detection signal to be processed in some way, where at the moment it is preferred to couple the detection signal to some display giving an almost ‘real-time’ representation of the actual concentration of the species in the tissue or media, but the signal may also be recorded within the housing for later access, such as in a monitoring application, or it may be transmitted out of the housing to a remote location for recording or further processing such as a process control application.

To minimize any pulsations of the flows the pumping means in the invention are based on constant pressure pumps, in a preferred embodiment implemented by storing each fluid in flexible reservoirs located inside a pressurized chamber being kept at a constant pressure. The fluids of each flexible reservoir are then squeezed into transporting means into the system. The individual flow rates of the fluids are then controlled by flow restricting means.

It is an object of this invention to make a device for analysing the concentration of a species within a medium like a fluid, and where the system is capable of a continuous on-line analysis, and where the system contains no mechanically movable parts like pistons or rotating parts. It is also an objective to create a system capable of maintenance by easily replacement of the exhausted reservoirs of the system. It's further and object to minimize the use of reagents and specifically, the reliance on a process of dialysis minimizes the risk of internal pollution of the analysing device as well as the risk of pollution of the analysing devise as well as the risk of pollution of the environment. All fluids consumed and produced in the analysis may be contained and retained in reservoirs within the housing. No contaminant particles or organisms will be aspirated which could disturb the measurement or cause clogging.

A first aspect of the invention in relation to prior art, is to avoid the connection of tube-to-tube, with thereby following manufacturing problems and risk of damage to the micro-dimensional and often fragile connecting tubes.

A second aspect of the invention is to insure that the connections of the channels aligns to insure laminar mixing, where the laminar flowing fluids are laminated in a multi-layer structure, without having the risk of turbulence arising from discontinuities in a connection between tubes.

A third aspect of the invention is the mixing channel having to be of a sufficient length to insure enough mixing, and without having to roll or fold a tube in order to minimize the room it takes up, again with the risk of damaging it.

All three aspects are solved forming fluid communicating channels n a substrate like silicon or glass, possibly covered with an elastomeric sheet or some other substrate to make the channels fluid tight. The connections between the individual channels the being directly formed in the substrate. To insure sufficient length of the channels for e.g. mixing, they are formed into meandering channels in the substrate.

An advantage by keeping constant flows of all fluids and using the same pressurizing means to propagate the fluids is that a substantially perfect laminar structure of two fluids can be obtained in simple T or Y type channel junctions.

This is realized by an analysis system comprising, Micro fluidic system for analysing species within a fluid medium, comprising: at least one first fluid reservoir holding a carrier fluid, a second fluid reservoir(s) holding reagent fluid(s) producing measurable chemical reactions when mixed with the species, detecting arrangement able to detect the measurable chemical reactions, a membrane permeable to the species, the membrane being in downstream fluid communication with the first fluid reservoir and in upstream fluid communication with analysing means, the first fluid reservoir(s) and the second fluid reservoir(s) being stored in storage container and in downstream fluid communication with pressurizing means through connecting means, characterized in that the analysing means comprise one substrate with micro-channels and covered in a fluid tight manner by a sheet, the micro-channels at said one substrate defining at least one meandering part(s) for mixing and/or reacting the reagent fluid(s) to the carrier fluid, and at least one meandering part for measuring the resulting detectable changes from the reaction, and an outlet for the waste fluid.

The device according to the invention is especially well suited for analysing the glucose concentration in human tissue, but may just as well be modified for analysing any other species in the tissue, human or animal. More general measurement and control of other fluid processes would also be within the scope of the invention, like fermentation process tanks, nutrient salts in waste water purification plants as well as natural water streams. Any media as gases, fluids and human or animal tissues may be analysed.

### BRIEF DESCRIPTION OF THE DRAWINGS

FIG. 1 is a schematic drawing of the micro-analysis system.

FIG. 2 is a Laminar 2-layer mixing in a Y-shaped junction.

FIG. 3a-b shows two alternative kinds of pressurizing means.

FIG. 4a-b shows two alternative set-ups of the pressurizing means.

FIG. 5 is a segmented mixing in a T-shaped junction.

FIG. 6 is a diagram showing when to use 2-layer laminar mixing and when to mix by segmentation.

### DETAILED DESCRIPTION OF THE INVENTION

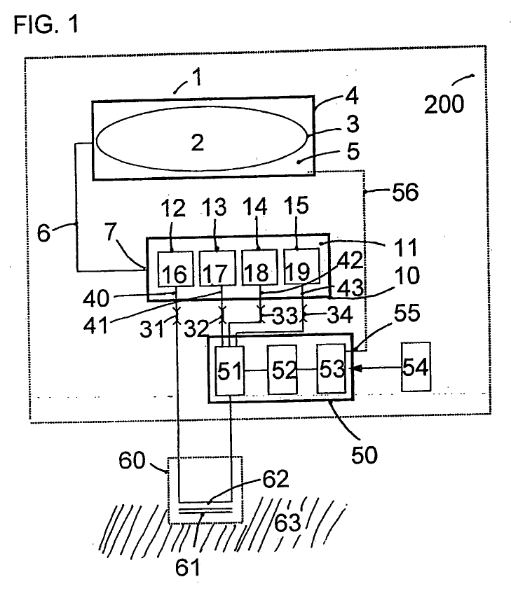

FIG. 1 is a schematic drawing of the operating part of the analysis system 200, with one carrier fluid 16 and three reagent fluids 17, 18 and 19, but any the number of reagent fluids would be possible. To insure constant flow rates fluids the pressurizing means 1 are preferable of the type comprising a variable volume chamber 2, where in a preferred embodiment of the invention the variable volume consists of an elastomeric bladder 3 containing some pressurized fluid, the bladder being in communication with the fluid chamber 11 in the storage container 10 via connecting line 6 and storage container inlet 7. Fluid chamber 11 is hereby filled with pressurized fluid, which exerts a constant force on the fluid reservoirs 12, 13, 14 and 15. The elastomeric bladder 3 acts hereby as constant pressure source, simultaneously acting on all of said fluid reservoirs via fluid chamber 11. This embodiment has the advantage that all the reservoirs 12, 13, 14 and 15 are exposed to the same constant pressure, which simplifies the control of amount of fluid delivered from the reservoirs. The elastomeric bladder 3 may itself be arranged within a protective container 4.

An elastomeric bladder are used as the illustrative example of the variable volume chamber of the pressurizing means, but the invention are not to be limited to this kind of pressurizing means, any means may be used when found more suitable.

The system comprises a first connection means 41, 42 and 43 for communicating the fluids from the fluid reservoirs 13, 14, 15 to the analysing means 50, where connection means in a preferred embodiment are capillary tubes, but may be any thinkable way to transfer a micro-fluid. To insure the correct flow rate of the individual fluids, flow restrictors 31, 32, 33 are placed downstream of the fluid reservoirs.

The analysing means 50 would in a preferred embodiment comprise a micro-system like the one in U.S. Pat. No. 5,644,395, where micro-channels are formed in a substrate like silicon or glass, possibly covered with an elastomeric sheet or some other substrate to make the channels fluid tight. The capillary tube 40 leads carrier fluid from carrier fluid reservoir 16 through the flow defining restrictor 30, to the sampling means 60, possibly in form of a probe, where a section 62 are in communication with the one side of the membrane 61. The membrane 61 is made of a material allowing transfer of ions or molecules from one side to the other. This will allow the migration of ions and molecules, from the media 63 through the membrane and into the flow of carrier fluid 16. As a result, the carrier fluid becomes loaded with ions or molecules from the media 63 and transforms into a sample fluid entering the mixing part 51 of the channel system in the analysing means 50.

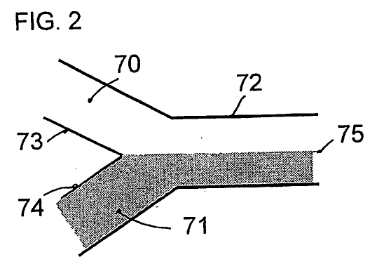

In the mixing channel 51 the sample fluid is mixed with the reagent fluids 17, 18 and 19 entering the analysing means 50 from the capillary tubes 41, 42 and 43 in rates determined by the pressure of the fluid chamber 11 and the flow restrictor means 31, 32 and 33. The mixing is preferably achieved in a laminated way as illustrated on FIG. 2, where two fluids 70 and 71 arrive to a common channel 72 from separate channels 73 and 74. This insure a relatively large contact area 75 of the two fluids 70, 71 and with a proper flow rate of the fluids and a proper length of the mixing channel 51 in relation to the flow rates and cross area of the channels, a sufficient mixing by diffusion occurs.

Back to FIG. 1 and following the mixed sample and reagent fluids 17, 18, 19 leaving the mixing part 51 entering the reaction part 52, where the mix of fluids has time to react, producing certain chemical reactions which can facilitate the measurement of species concentrations in a suitable detector arrangement 54 known in the art, as the fluid passes the measuring part 5. The detector arrangement 54 are able to generate a signal representative of the species concentrations, and the signal may be transformed to some optical display, recorded within the system or the system may be on-line connected to some remote location monitoring the system receiving the signal. Some audio representation or alarm responding to some predefined border values may also be incorporated. When the fluid has passed the measuring part 53, it leaves the analysing means 50 through a waste outlet 55.

The channel system in the analysis means 50 are often long and meandering, where some parts of the system define one or more mixing parts 51, one or more reaction parts 52 and one or more measuring parts 53. The simple set-up is the mixing part 51 followed by the reaction part 52 followed by the measuring part 53, but any permutation of any number of the parts 51, 52, 53 may be used in the system.

To minimize the total size of the analysis-system, the chamber 5 may play the dual role of containing the elastomeric bladder 3 and being reservoir for the waste in the system. A waste fluid channel 56 may be connected to the waste outlet 55; communicating analysing means 50 with chamber 5 inside protective container 4. During operation of the system, the volume of elastomeric bladder 3 decreases as the fluid inside continuously is displaced into fluid chamber 11. The resulting free space in chamber 5 is then used as waste reservoir making the system a self-contained.

In one embodiment the waste may be lead into a separate flexible container 8 being inside the protecting housing 4.

The separation of the pressurizing means 1 on FIG. 1 and the fluid chamber 10 from the analysing means 50, makes an easy exchange of exhausted reservoirs 12, 13, 14, 14, and the pressurizing means 1 may be exchanged at the same time, possible being assembled in a combined package. Possible it is just the variable volume chamber 2 and reservoirs 12, 13, 14, 15 that are exchanged or the whole combination with protective housing 4 and fluid chamber 10 too.

If the waste is lead back into the protective chamber 10, then they are removed from the system as the exhausted reservoirs are removed, and new ones insert into the system.

The membrane 61 materiel is selected among materials, which essentially only allow transfer of ions and molecules smaller than a certain size across the membrane. Using a membrane made from an impermeable material and subjecting it to perforation by irradiation, which will form very narrow channels in the membrane, may achieve this. Workers in the field of dialysis and osmosis know other suitable permeable membranes. Optionally the membrane can be covered with a permeable protective matrix placed in such a way that the protective matrix is contracting the medium to be analysed, that is, on the front side or first major surface of the membrane.

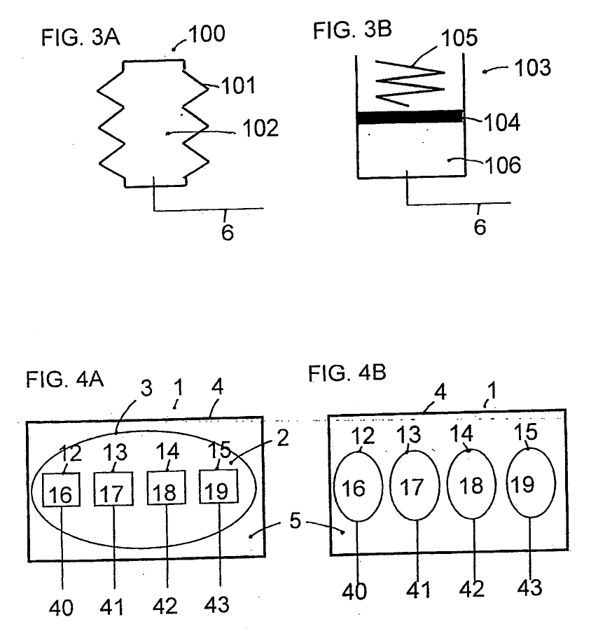

Other pressurizing means 1 than an elastomeric bladder 3 may be possible. The elastomeric bladder 3 may be replaced by a bellows capsule 100 (FIG. 3a) expanded by a pressuring fluid 102 inside and squeezing this fluid into the connection line 6 as the expanded sides 101 of the bellows capsule, return to the relaxed state, the same way as the elastomeric bladder functions. Another possibility could be to have a variable volume chamber 103 (FIG. 3b) with at least one movable wall 104, and mechanically working means like a spring 105, or a shape memory alloy returning to it original shape when heated, exerting a pressure on the movable wall of the variable volume chamber 103, thereby squeezing the pressuring fluid into the connection line 6.

The pressurizing means 1 could in another embodiment be replaced by a system where each of the fluid reservoirs 12, 13, 14, 15 is placed directly inside the variable volume chamber 2, as is illustrated at FIG. 4a. As the elastomeric bladder 3 compresses the volume 2 in the same way as before, the pressure is directly on each of the fluid reservoirs squeezing the fluids 16, 17, 18, 19 into the connecting means 40, 41, 42, 43.

Alternatively, as illustrated on FIG. 4b, each of the flexible containers 12, 13, 14, and 15 are themselves the pressurizing means, possible elastomeric bladders, bellow capsules or other kinds or the like, each individually squeezing the fluids 16, 17, 18 and 19 into the system. An disadvantage using this implementation, is a loss of control of the correlation between the individual flows of the fluids 16, 17, 18 and 19, due to the fact that the fluids no longer are exposed to the same constant pressure source.

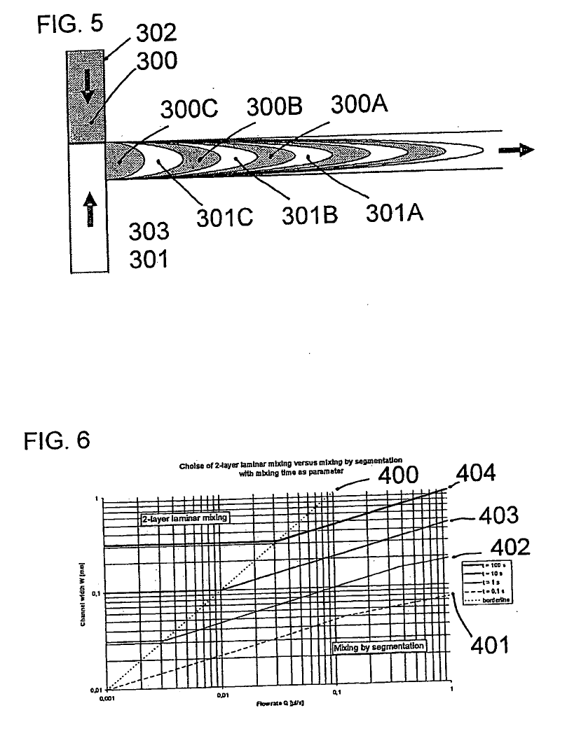

Under laminar flow conditions fluids may be mixed in different ways, where FIGS. 5 and 6 shows two different ways. On FIG. 5 the two fluids are fed to a common Y- or T-junction in a segmented way. A first fluid 300 and a second fluid 301 arrives to a common channel 304 from separate channels 302 and 303 respectively. By administering the flows of the fluids 300, 301 it is possible to feed them into the common channel 304 in alternate plugs like 301a, 300a, 301b, 300b, 301c, 300c. The laminar flow conditions insures that the part of the plugs close to the channel 304 flows at a slower flow rate than the part at the centre, so more and more pointed profiles of the plugs are achieved, as seen from the plug 300c to 300a. By defining the pulse-sizes correctly, the segmented mixing has the advantage that mixing occurs in both radial and axial direction.

A more simple way to mix the fluids is the 2-layer lamination explained before and illustrated on FIG. 2.

Multi-layer lamination with constant flow-rates are also a possibility, where two liquids are fed to a mixer structure such as the ones described in the patents U.S. Pat. No. 6,190,034 and U.S. Pat. No. 6,241,379.

The requirement for the pumps supplying the two liquids is different for segmentation and lamination respectively. For the segmentation method each pump must supply accurate pulses of liquid, out of phase. The optimum pulse-size for a W×W square cross-sectional cannel, where W is the channel width, is a volume of 2*W³, which is a compromise between making the smallest possible plug and almost symmetric plug formation at the Y- or T-junction (an Y-junction is shown on FIG. 2 and a T-junction on FIG. 5). For small systems with W<0.1 mm the plug-volume become <2 nl, and it become challenging to construct a pump with good performance. For the lamination mixing it is feasible to build a constant flow pump based on the constant pressure pumping concept.

In order to choose between the two mixing methods one would in general want to optimise in terms of shortest possible mixing time. But, as stated above, in some cases the availability of a suitable pumping technology may also play a role.

It can be shown that the mixing time for 2-layer lamination under laminar flow conditions is approximately given by:

$${T}_{mix\_ 2 - layer} = \frac{{W}^{2}}{D}$$

where W is the channel width and D is the diffusion constant.

It can also be shown that the mixing time for mixing by segmentation is given by:

$${T}_{mix\_segmentation} = max \{ \frac{2 {W}^{5 / 2}}{\sqrt{QD}} ; \frac{100 {W}^{3}}{Q} \}$$

where W is the channel width and D is the diffusion constant and Q is the flow-rate.

The reason for two different rules in this formula has to do with the requirement in mixing by segmentation to obtain sufficient mixing in both radial and axial direction.

FIG. 6 is an illustration of 2-layer laminar mixing versus mixing by segmentation time as parameter, where a typical diffusion constant for small molecules of 0.001 mm²/s is assumed in this example. Combinations channel widths W and flow rates Q that gives mixing times of 0.1 second, 1 second, 10 seconds and 100 seconds, are shown as the lines 401, 402, 403 and 404 respectively. Left of the borderline 400, the calculations are for 2-layer laminar mixing and at right for borderline 400 the calculations are for mixing by segmentation.

While the present invention has been illustrated and described with respect to a particular embodiment thereof, it should be appreciated by those of ordinary skill in the art that various modifications to this invention may be made without departing from the spirit and scope of the present invention.

1-11. (canceled)

12. A micro fluidic system for analysing species within a fluid medium comprising:
at least one first fluid reservoir holding a carrier fluid,
a second fluid reservoir(s) holding reagent fluid(s) producing measurable chemical reactions when mixed with the species,
detecting arrangement able to detect the measurable chemical reactions,
a membrane permeable to the species, the membrane being in downstream fluid communication with the first fluid reservoir and in upstream fluid communication with analysing means,
the first fluid reservoir(s) and the second fluid reservoir(s) being stored in storage container and in downstream fluid communication with pressurizing means through connecting means, wherein the analysing means comprise one substrate with micro-channels and covered in a fluid tight manner by a sheet, the micro-channels at said one substrate defining at least one meandering part(s) for mixing and/or reacting the reagent fluid(s) to the carrier fluid, and at least one meandering part for measuring the resulting detectable changes from the reaction, and an outlet for the waste fluid.

13. The system according to claim 12, wherein a flow restrictor is inserted between the permeable membrane and the first fluid reservoir.

14. The system according to claim 13, wherein the pressurizing means comprise a variable volume chamber with at least one movable wall, the variable volume chamber being expanded by a pressurizing fluid at the inside, squeezing the fluid into the connection line as the expanded movable wall(s) of the volume chamber returns to the relaxed state.

15. The system according to claim 13, wherein said variable volume chamber is an elastomeric bladder.

16. The system according to claim 12, wherein:
the first fluid reservoir holding the carrier fluid,
the second fluid reservoir(s) holding the reagent fluid(s),
and the pressurizing means,
are arranged in a common, exchangeable package.

17. The system according to claim 12, wherein the pressurizing means are arranged within a protective container.

18. The system according to claim 17, wherein the outlet for the waste fluid is in fluid communication with the inside of the protective container of the pressurizing means.

19. The system according to claim 12, wherein sample fluid and said reagent fluid(s) being mixed by laminar mixing in at least two layers.

20. The system according to claim 19 wherein sample fluid and said reagent fluid(s) being mixed by laminar mixing in at least three layers.

21. The system according to claim 12, where a first and a second fluid are mixed in a segmented way, so that the mixed fluid comprise alternating plugs of said first fluid and said second fluid.
